(19) United States
(12) Patent Application Publication
(10) Pub. No.: US 2025/0379256 A1
(43) Pub. Date: Dec. 11, 2025

(54) MODERATELY SOLVATING ELECTROLYTES FOR RECHARGEABLE METAL-SULFUR BATTERIES

(71) Applicant: BATTELLE MEMORIAL INSTITUTE, Richland, WA (US)

(72) Inventors: Wu Xu, Richland, WA (US); David J. Kautz, San Antonio, TX (US); Xia Cao, Richland, WA (US)

(73) Assignee: BATTELLE MEMORIAL INSTITUTE, Richland, WA (US)

(21) Appl. No.: 19/216,089

(22) Filed: May 22, 2025

Related U.S. Application Data
(60) Provisional application No. 63/651,761, filed on Jun. 6, 2024.

(51) Int. Cl. H01M 10/0569; H01M 10/052; H01M 10/0568

(52) U.S. Cl. CPC H01M 10/0569; H01M 10/052; H01M 10/0568; H01M 2300/004

(57) ABSTRACT

Embodiments of the invention are related to moderately solvating electrolytes (MSEs) and rechargeable metal-sulfur batteries containing such electrolytes. Electrolytes include a metal salt, a highly solvating solvent, a weakly or lowly solvating solvent, and a non-solvating solvent (or diluent). Example rechargeable batteries including such electrolytes are lithium-sulfur (Li—S), sodium-sulfur (Na—S), potassium-sulfur (K—S), magnesium-sulfur (Mg—S), and aluminum-sulfur (AI-S) batteries.

### RELATED APPLICATIONS

This application claims benefit of U.S. Provisional Patent Application No. 63/651,761 filed Jun. 6, 2024. This referenced application is hereby incorporated herein by reference in its entirety.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

### Field of the Invention

Embodiments of the invention are related to moderately solvating electrolytes (MSEs) that have moderate solubility of polysulfide (PS) species and are stable between a metal anode and PSs formed from the sulfur(S) cathode in metal-S batteries such as lithium (Li)—S batteries, sodium (Na)—S batteries, potassium (K)—S batteries, magnesium (Mg)—S batteries, aluminum (Al)—S batteries, and the like.

### Background Information

Conventional carbonate electrolytes, e.g. lithium hexafluorophosphate (LiPF₆) in ethylene carbonate (EC) and ethyl methyl carbonate (EMC) or LiPF₆ in EC and dimethyl carbonate (DMC) have good compatibility with the state of the art 4 V transition metal cathodes and graphite anodes used in Li-ion batteries. However, these electrolytes have poor stability with Li metal anodes and S cathodes. Ether based electrolytes (such as lithium bis(trifluoromethanesulfonyl)imide (LiTFSI) in 1,2-dimethoxyethane (DME) and 1,3-dioxolane (DOL), lithium trifluoromethanesulfonate or lithium triflate (LiCF₃SO₃) in DME and diethylene glycol dimethyl ether (DEGDME)) exhibit better compatibility with Li metal. However, PSs are highly soluble in these electrolytes and lead to a PS shuttle effect and low Coulombic efficiency (CE). Electrolytes including an appreciable concentration of lithium polysulfides (LiPSs) (like Li₂S₆) shift the equilibria involving long-chain LIPSs thereby altering the other species of the PSs in the solution, but these electrolytes usually exhibit high viscosity and low conductivity. High concentration electrolytes, e.g. concentrated LiTFSI/DME, or concentrated LiTFSI/triethyl phosphate (TEPa) can enable high CE for a Li metal anode, due to the formation of a stabilized solid electrolyte interphase (SEI) layer and reduction of free solvent molecules and salt anions. However, these highly concentrated electrolytes suffer from high cost, high viscosity, and poor wetting capability toward a polyolefin separator and a thick cathode electrode, hindering their practical use. A need exists for improved rechargeable metal-S batteries. Embodiments of this invention introduces a series of new electrolyte solvents for rechargeable metal-S batteries. These solvents have limited LiPS solubility and are stable with generated PSs and metal anodes.

### SUMMARY

Embodiments of the present invention provide improved metal-S batteries by providing improved electrolytes yielding improved electrolyte solvent combinations that may be used in such batteries. These electrolytes have limited LiPS solubility and are stable with generated PSs and metal anodes. In some embodiments, batteries incorporating such improved electrolytes may include, for example, a sulfur containing cathode (positive electrode), a Li or other metal anode (negative electrode), a separator located between the electrodes, the improved electrolyte (also provided Li ions or other metal ions between the electrodes), and one or more cell containers or cases for holding the cathode, anode, separator, and electrolyte, and electrically isolated terminals for making external connections.

Embodiments of the present invention provide moderately solvating electrolytes (MSEs) to form high efficiency non-aqueous electrolytes for metal-S batteries. These improved MSEs exhibit moderate Li salt concentration, low viscosity, excellent wetting ability with regard to electrodes and intermediate separators. These improved MSEs also provide great compatibility with metal anodes and S cathodes. They are also highly stable with alkaline metal anodes, including Li metal anodes. These MSEs have limited solubility for LiPSs generated from the S cathodes during discharging and charging processes, thereby largely limiting the shuttle effect which is one of the most significant barriers for Li—S batteries. These MSEs generate high-quality SEI layers on both metal anode and S cathodes, thereby improving the long-term cycling stability of the metal-S batteries. As a result, these electrolytes significantly improve the CE and decrease the self-discharge of metal-S batteries during energy storage. Embodiments of this invention, mutatis mutandis, can be widely applied to a variety of electrochemical systems, including Li—S, Na—S, Mg—S, and Al—S batteries.

These MSEs were prepared by dissolving the Li salt in a ternary solvent mixture that is comprised of a highly solvating solvent, a weakly (or lowly) solvating solvent, and a non-solvating solvent (or diluent). The highly solvating solvent refers to the solvents with LiPS solubility over 0.5 M, including, for example, DME, 1,3-dimethyl-2-imidazolidinone (DMI), dimethylformamide (DMF), dimethyl sulfoxide (DMSO), and the like. The weakly solvating solvent refers to the solvents with LiPS solubility between 0.05 M and 0.5 M [S], including, for example, 2-methyltetrahydrofuran (2-MeTHF), 1,2-diethoxyethane (DEE), tetrahydropyran (THP), 4-methyl-tetrahydropyran (4-MeTHP), and the like. The non-solvating solvent or diluent refers to the solvents with LiPS solubility below 0.05 M, including, for example, tris(2,2,2-trifluoroethyl) orthoformate (TFEO), triethyl orthoformate (TEO), trimethyl orthoformate (TMO), 1,1,2,2-tetrafluorethyl-2,2,3,3-tetrafluoropropyl ethane (TTE), bis(2,2,2-trifluoroethyl) ether (BTFE), 1H,1H,5H-octafluoropentyl 1,1,2,2-tetrafluoroethyl ether (OTE), 1,2-bis(1,1,2,2-tetrafluoroethoxy) ethane (BTFEE), 2,2,2-trifluoroethyl 1,1,2,2-tetrafluoroethyl ether (TTEE), 1,1,1,3,3,3-hexafluoro-2-(fluoromethoxy) propane (HFP), ethyl 1,1,2,2-tetrafluoroethyl ether (ETE), ethyl nonafluorobutyl ether (ENFBE), methyl nonafluorobutyl ether (MNFBE), methyl butyl ether (MBE), ethyl butyl ether (EBE), dibutyl ether (DBE), and the like. The formulated electrolytes (i.e. MSEs) show limited or moderate solubility of LiPS with a LiPS solubility between 0.05 M and 0.5 M, which significantly decreases the shuttle of PSs and increases the CE of the cells. Unlike methods using high concentration electrolytes (i.e., electrolytes with a salt concentration over 3 M), the MSEs of some embodiments of the present invention can lead to reduced viscosity of the electrolytes and greatly improve their wettability with regard to the separator and with regard to high loading S cathodes, thereby enhancing the electrochemical performance of metal-S batteries. Through electrolytes of some embodiments of the present invention can accept added LiPS such an addition is not required which can lead to further improvements. By carefully selecting the weakly solvating solvents and non-solvating solvents (or diluents) and optimizing the electrolyte formulations through adjusting the ratios of salt (e.g., LiTFSI, LiSO3DF3, or LiNO3) and co-solvents, practical rechargeable metal-S batteries with significantly improved safety and significantly improved charge/discharge performance can be achieved.

Some embodiments of the current invention enable stable operation of high areal capacity loading Li—S batteries with high CE and moderate PS solubility. The improved electrolytes not only possess the unique functionality of having a low PS shuttle effect they can also provide improved non-flammability by the inclusion of fluorinated orthoformates or ethers. In some embodiments one or more of the following advantages are provided while others may also be provided:
Stability with both Li metal anodes and S cathodes while exhibiting a high CE during Li cycling.
Effectively decreasing the LiPS solubility in the electrolyte.
Low PS shuttle and less self-discharge during storage.
Low viscosity and high conductivity compared with highly concentrated electrolytes.
Ability to achieve high ionic conductivity and non-flammability of the electrolytes by adding and adjusting the different components (e.g., organic phosphorous solvents or additives) of the electrolytes.
Generation of high-quality SEI layers on both metal anode and sulfur cathodes.
Improving long-term cycling stability of metal-S batteries.

In a first aspect of the invention a moderately solvating electrolyte for a rechargeable Li—S battery includes: (a) a lithium salt; (b) a first highly solvating solvent for lithium polysulfides (LiPSs); (c) a second weakly solvating solvent for LiPSs; and (d) a third non-solvating solvent or diluent for LiPSs.

Numerous variations of the first aspect of the invention exist and include, for example: (1) the first highly solvating solvent including a solvent selected from the group of: (b1) 1,2-dimethoxyethane (DME); (b2) 1,3-dimethyl-2-imidazolidinone (DMI); (b3) dimethylformamide (DMF); (b4) dimethyl sulfoxide (DMSO); and (b5) a combination of two or more of (b1)-(b4); (2) the first aspect or the first variation thereof wherein the second weakly solvating solvent includes a solvent selected from the group consisting of: (c1) 2-methyltetrahydrofuran (2-MeTHF); (c2) 1,2-diethoxyethane (DEE); (c3) tetrahydropyran (THP); (c4) 4-methyl-tetrahydropyran (4-MeTHP); and (c5) a combination of two or more of (c1)-(c3); (3) the first aspect or either of the first or second variations thereof wherein the third non-solvating solvent or diluent includes a solvent or diluent selected from the group consisting of: (d1) tris(2,2,2-trifluoroethyl) orthoformate (TFEO); (d2) triethyl orthoformate (TEO), (d3) trimethyl orthoformate (TMO); (d4) 1,1,2,2-tetrafluorethyl-2,2,3,3-tetrafluoropropyl ethane (TTE); (d5) bis(2,2,2-trifluoroethyl) ether (BTFE); (d6) 1H,1H,5H-octafluoropentyl 1,1,2,2-tetrafluoroethyl ether (OTE); (d7) 1,2-bis(1,1,2,2-tetrafluoroethoxy) ethane (BTFEE); (d8) 2,2,2-trifluoroethyl 1,1,2,2-tetrafluoroethyl ether (TTEE); (d9) 1,1,1,3,3,3-hexafluoro-2-(fluoromethoxy) propane (HFP); (d10) ethyl 1,1,2,2-tetrafluoroethyl ether (ETE); (d11) ethyl nonafluorobutyl ether (ENFBE); (d12) methyl nonafluorobutyl ether (MNFBE); (d13) methyl butyl ether (MBE); (d14) ethyl butyl ether (EBE); (d15) dibutyl ether (DBE); and (d16) a combination of two or more of (d1)-(d15); (4) the first aspect or any of the first or third variations thereof additionally including (e) a redox mediating additive different from the salt, solvent of diluent of (a), (b), (c), and (d); (5) the fourth variation of the first aspect wherein the redox mediating additive includes an additive selected from the group of: (e1) lithium bromide (LiBr), (e2) thiourea (TU), and (e3) a combination of LiBr and TU; (6) the fifth variation of the first aspect wherein the highly solvating solvent provides a solubility for LiPS over 0.5 M, the weakly solvating solvent provides a solubility for LiPS in the range of 0.05 M to 0.5 M, and the non-solvating solvent or diluent provides a solubility for LiPS below 0.05 M while the electrolyte as a whole provides a solubility for the LIPS in the range of 0.05M to 0.5 M; and (7) the sixth variation of the first aspect wherein the lithium salt is provided in a range selected from the group of: (A) 0.1 M to 2.0 M, (B) 0.3 M to 1.5 M, and (C) 0.6 M to 1.0 M.

In a second aspect of the invention a moderately solvating electrolyte for a rechargeable metal-sulfur battery comprising: (a) a salt of the metal; (b) a first highly solvating solvent for PSs; (c) a second weakly solvating solvent for PSs; and (d) a third non-solvating solvent or diluent for PSs.

Numerous variations of the second aspect of the invention are possible and include for example: (1) the metal including a metal selected from the group of: (A) lithium, (B) sodium, (C) potassium, (D) magnesium, and (E) aluminum; and (2) any of the variations of the first aspect of the invention wherein the metal includes lithium; and (3) any of the variations of the first aspect, mutatis mutandis, wherein the metal includes sodium; (4) any of the variations of the first aspect, mutatis mutandis, wherein the metal includes potassium; (5) any of the variations of the first aspect, mutatis mutandis, wherein the metal includes magnesium; and (6) any of the variations of the first aspect, mutatis mutandis, wherein the metal includes aluminum.

In a third aspect of the invention a metal-sulfur battery, includes: (a) a cathode, comprising sulfur; (b) an anode, comprising the metal; (c) an electrolyte, comprising: (i) a salt of the metal; (ii) a first highly solvating solvent for PSs; (iii) a second weakly solvating solvent for PSs; and (iv) a third non-solvating solvent or diluent for PSs.

Numerous variations of the third aspect of the invention exist and include, for example: (1) the metal including a metal selected from the group consisting of (A) lithium, (B) sodium, (C) potassium, (D) magnesium, and (E) aluminum (2) the metal including lithium, the PSs including LiPS, and the metal-sulfur battery including a lithium-sulfur battery; (3) the second variation of the third aspect wherein the first highly solvating solvent includes a solvent selected from the group of: (ii1) 1,2-dimethoxyethane (DME); (ii2) 1,3-dimethyl-2-imidazolidinone (DMI); (ii3) dimethylformamide (DMF); (ii4) dimethyl sulfoxide (DMSO); and (ii5) a combination of two or more of (ii1)-(ii4); (4) the second or third variations of the third aspect wherein the second weakly solvating solvent includes a solvent selected from the group consisting of: (iii1) 2-methyltetrahydrofuran (2-MeTHF); (iii2) 1,2-diethoxyethane (DEE); (iii3) tetrahydropyran (THP); (iii4) 4-methyl-tetrahydropyran (4-MeTHP); and (iii5) a combination of two or more of (iii1)-(iii4); (5) any of the second to fourth variations of the third aspect wherein the third non-solvating solvent or diluent, includes a solvent or diluent selected from the group consisting of: (iv1) tris(2,2,2-trifluoroethyl) orthoformate (TFEO); (iv2) triethyl orthoformate (TEO); (iv3) trimethyl orthoformate (TMO); (iv4) 1,1,2,2-tetrafluorethyl-2,2,3,3-tetrafluoropropyl ethane (TTE); (iv5) bis(2,2,2-trifluoroethyl) ether (BTFE); (d6) 1H,1H,5H-octafluoropentyl 1,1,2,2-tetrafluoroethyl ether (OTE); (iv7) 1,2-bis(1,1,2,2-tetrafluoroethoxy) ethane (BTFEE); (iv8) 2,2,2-trifluoroethyl 1,1,2,2-tetrafluoroethyl ether (TTEE); (iv9) 1,1,1,3,3,3-hexafluoro-2-(fluoromethoxy) propane (HFP); (iv10) ethyl 1,1,2,2-tetrafluoroethyl ether (ETE); (iv11) ethyl nonafluorobutyl ether (ENFBE); (iv12) methyl nonafluorobutyl ether (MNFBE); (iv13) methyl butyl ether (MBE); (iv14) ethyl butyl ether (EBE); (iv15) dibutyl ether (DBE); and (iv16) a combination of two or more of (iv1)-(iv15); any of the second to fifth variations of the third aspect wherein the electrolyte additionally includes (v) a redox mediating additive different from the salt of (i), solvents or (ii) and (iii), and the diluent of (iv); (7) the sixth variation of the third aspect wherein the redox mediating additive includes an additive selected from the group of: (v1) lithium bromide (LiBr), (v2) thiourea (TU), and (v3) a combination of LiBr and TU; (8) any of the second to seventh variations of the third aspect wherein the highly solvating solvent provides a solubility for LiPS over 0.5 M, the weakly solvating solvent provides a solubility for LiPS in the range of 0.05 M to 0.5 M, the non-solvating solvent or diluent provides a solubility for LiPS below 0.05 M, and the electrolyte as a whole provides a solubility for the LiPS in the range of 0.05M to 0.5 M; (9) any of the second to eighth variations of the third aspect wherein the lithium salt is provided in a range selected from the group of: (A) 0.1 M to 2.0 M, (B) 0.3 M to 1.5 M, and (C) 0.6 M to 1.0 M; (10) any of the second to ninth variations of the third aspect additionally comprising a separator; and (11) the third aspect or any of the second to tenth variations wherein the battery provides a number of useful charging-discharging cycles prior to a specific capacity of the battery falling below 80% of a peak specific capacity of the battery, wherein the number of cycles is selected from the group of: (A) greater than 100 cycles, (B) greater than 200 cycles, (C) greater than 250 cycles, and (D) greater than 300 cycles.

In a fourth aspect of the invention a metal-S battery, includes: (a) a cathode, including S; (b) an anode, including the metal; (c) an electrolyte, including: (i) a salt of the metal; (ii) a first highly solvating solvent for PSs; (iii) a second weakly solvating solvent for PSs; and (iv) a third non-solvating solvent or diluent for PSs.

Numerous variations of the fourth aspect of the invention are possible and include for example: (1) those noted for the first to third aspects of the invention, (2) the metal being Na and the battery being a Na—S battery; (3) the metal being K and the battery being a K—S battery; (4) the metal being Mg and the battery being a Mg—S battery; and (5) the metal being Al and the battery being an Al—S battery.

Other objects and advantages of various aspects and embodiments of the invention will be apparent to those of skill in the art upon review of the teachings herein. The various aspects and embodiments of the invention, set forth explicitly herein or otherwise ascertained from the teachings herein, may address any one or more of the above objects or advantages either alone or in combination. Alternatively or additionally such embodiments or aspects may address some other object or provide some other advantage ascertained from the teachings herein. It is not intended that any specific aspect or embodiment of the invention necessarily address all objects or advantages simultaneously.

### BRIEF DESCRIPTION OF THE DRAWINGS

This application contains at least one drawing executed in color. Copies of this patent or patent application publication with color drawing(s) will be provided by the Office upon request and payment of any necessary fee.

FIG. 1 is a first table providing a comparison of physical properties for DME, DOL, 2MeTHF, and TFEO.

FIG. 2 is a second table listing a baseline electrolyte and four MSE example electrolytes according to some embodiments of the invention along with some of their basic properties.

FIG. 3 provides a graph showing the results of CE tests of Li metal in different electrolytes using Li∥Cu (copper) cells.

FIG. 4 provides a qualitative comparison of PS solubility in different electrolytes after stirring for 16 hours at 55° C., wherein the lighter colors indicate less PS solubility.

FIG. 5 provides a graph illustrating cycling performance of Li∥S cells using different electrolytes in terms of capacity (bright, colored lines) and CE (faded lines) at a C/10 charging/discharging rate.

FIGS. 6A and 6B provide voltage profiles of Li∥S cells vs cycling in different electrolytes with FIG. 6A showing results from cycling using a baseline electrolyte while FIG. 6B shows results for cycling using a 0.8M DMFN electrolyte of an embodiment of the invention.

FIG. 7 provides profiles of cycling performance of Li∥S cells using different electrolytes in terms of capacity and CE, like that shown in FIG. 5 but at a C/5 charging/discharging rate.

FIGS. 8A and 8B provide voltage profiles of Li∥S cells cycling in the different electrolytes with FIG. 8A showing results from cycling using a baseline electrolyte while FIG. 8B shows results for cycling using the 1.0M DMFN electrode with both using parameters like those used in generating FIG. 7.

FIG. 9A-9C provide respective scanning electron microscopy (SEM) images of (1) the surface of a pristine S electrode (FIG. 9A), (2) the electrode surface after 300 cycles at C/5 using a baseline electrolyte (FIG. 9B), and (3) the electrode surface after 300 cycles at C/5 using a 1.0M DMFN electrolyte of an embodiment of the invention (FIG. 9C).

FIGS. 10A and 10B provide X-ray diffraction (XRD) patterns of a pristine S electrode, a cycled S electrode after 1st discharge, and a cycled S electrode after a 1st charge formation cycle at a C/20 rate with FIG. 10A providing results from using a baseline electrolyte and FIG. 10B providing results from using a 1.0M DMFN electrolyte.

FIGS. 11A-11B provide photographs of Li metal anodes that were cycled 300 times at a C/5 rate respectively using a baseline electrolyte (FIG. 11A) and a 1.0M DMFN electrolyte (FIG. 11B).

FIGS. 11C and 11D provide SEM images of the morphology of the surface of Li after the cycling used in obtaining the images of FIGS. 11A and 11B, respectively.

FIGS. 11E and 11F provide, respectively, SEM images of the cross-sectional morphology of the Li after the cycling used in obtaining the images of FIGS. 11A and 11B, respectively.

FIGS. 12A and 12B provide graphs of specific capacity values versus cycle count for Li∥S cells respectively using different electrolytes and at different charge rates ranging from C/20 to C but at a constant discharge rate of C/10 (FIG. 12A) and a constant charge rate of C/10 but with different discharge rates ranging from C/20 to C (FIG. 12B).

FIG. 13 provides graphs of for a series of self-discharge voltage decay comparisons of fully charged Li∥S cells with different electrolytes.

FIG. 14 provides graphs comparing charge/discharge capacities of Li∥S batteries with different electrolytes after 28 self-discharge tests with each test occurring over a 1-week (168 h) interval at room temperature.

FIG. 15 is a third table setting forth an example baseline formulation and formulations for an additional four MSEs along with their CEs.

FIGS. 16A and 16B respectively provide graphs of specific capacity vs cycle number and CEs versus cycle number for Li∥S cells using different electrolytes much like those of FIGS. 5 and 7 but with different electrolytes.

FIGS. 17A and 17B respectively provide performance graphs of specific capacities vs cycle number and CEs vs cycle number for cells that include 1.0M of the DMFN electrolyte alone and the with DMFN electrolyte supplemented with different additives.

FIG. 18A provides comparison plots of voltage (V vs. Li/Li+) versus specific capacity of 1 Ah Li∥S pouch cells for both the baseline electrolyte and the 0.8M-DMFN electrolyte while FIG. 18B provides specific capacity versus cycle number plots showing the change of both charge and discharge capacities with cycling for the same pouch cells with the same two electrolytes where it can be seen that the 0.8M-DMFN cell shows better cycling stability than E-baseline cell.

### DETAILED DESCRIPTION OF THE PREFERRED EMBODIMENTS

Various advantages and novel features of some embodiments of the present invention are described herein and will become even more apparent to those skilled in this art from the following detailed description. In the preceding and following descriptions various embodiments of the invention are set forth including the best mode contemplated for carrying out the invention. As will be apparent to those of skill in the art after reviewing the teachings set forth herein, embodiments of the invention are capable of modification in various respects without departing from the spirit of invention. Accordingly, the drawings and description of the embodiments set forth hereafter are to be regarded as illustrative in nature, and not as restrictive.

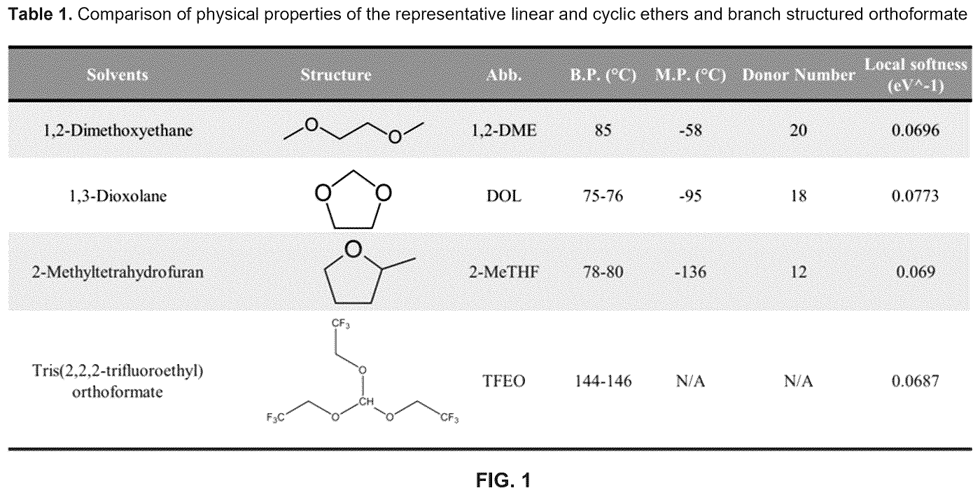

The performances of Li∥Cu, Li∥Li, Li∥S cells using different electrolyte formulations containing orthoformate solvents were investigated. FIG. 1 provides a first table (Table 1) that shows the physical properties of a representative linear ether (DME), representative of cyclic ethers (DOL, 2-MeTHF), and a branched ether (TFEO). Compared to the commonly used DME and DOL, TFEO has a much higher boiling point (bp) which benefits its potential application at elevated temperatures.

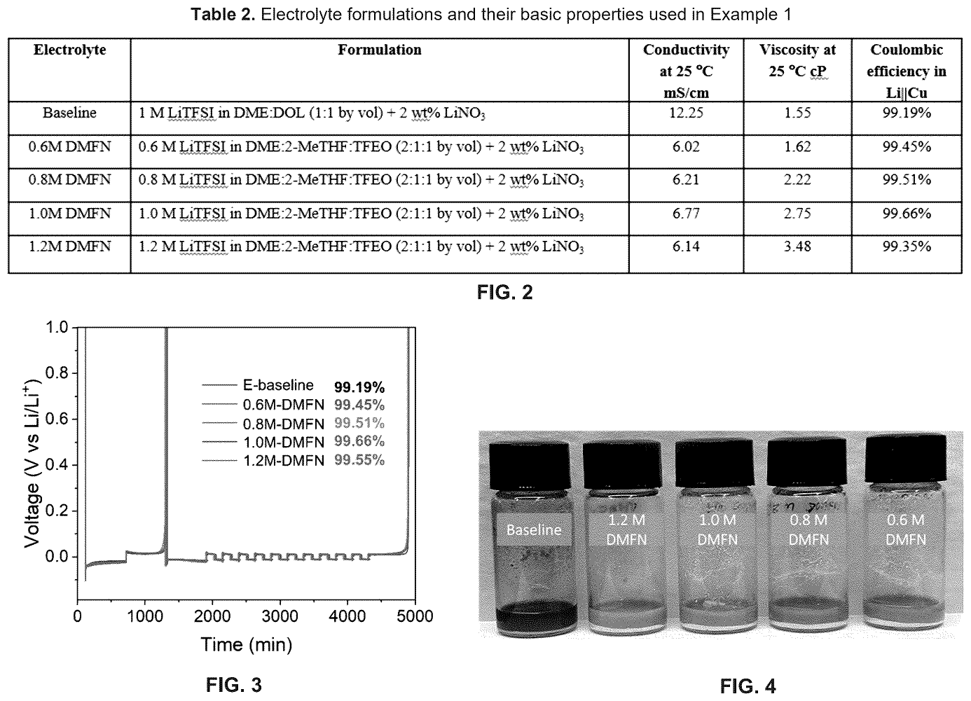

FIG. 2 provides a second table (Table 2) showing formulations of four tri-solvent electrolytes, referred to as DMFN from this point forward, together with the conventional DME:DOL based electrolyte as the baseline electrolyte for this work. As shown in FIG. 2, the DMFN electrolytes, based on ethers and TFEO, have slightly higher viscosity and lower conductivity based on their indicated binding energies than the baseline DME:DOL electrolyte, however, the DMFN electrolytes have higher CE than the baseline electrolyte as obtained from the Li CE tests in Li∥Cu cells shown in FIG. 3. The Li CE was tested using the protocol reported in the paper by Adams, et al., entitled “Accurate determination of coulombic efficiency for lithium metal anodes and lithium metal batteries”, Advanced Energy Materials, 2018, 8, 1702097. This referenced paper is incorporated herein by reference as if set forth in full.

TFEO has previously been reported to be used as a diluent in electrolytes for Li metal batteries with conventional layered oxide cathodes and was shown to improve performance and stability of the Li metal anode via enhancing the properties of the SEI that is formed with the addition of the TFEO solvent. However, it is believed that TFEO has not been reported for use in Li—S batteries. There is also no known reported combination of 2-MeTHF and TFEO for Li metal electrolytes. Some embodiments of the present invention, include DME (a solvent providing high solubility for PSs) in combination with these two selected solvents (that provide limited to no-solubility for PSs) to provide a new class of electrolytes with moderate solubility of PSs, to improve the stability of both S cathode and Li metal anode and to largely improve the performance of the Li—S batteries as a whole. The resulting electrolytes also maintain low Li salt concentration, reduced viscosity, and moderately high ionic conductivity, high coulombic efficiency, and result in more stable long-term energy storage by Li—S batteries.

The solubility of PS in different electrolytes was tested by adding Li₂S and S₈ at a molar ratio of 1:7 in each tested electrolyte and heated at 55° C. under stirring for 16 hours (h) inside an argon-filled glovebox. After cooling to room temperature, the mixtures in the vials were photographed as shown in FIG. 4. Compared to the baseline electrolyte, the DMFN electrolytes with varied LiTFSI concentrations show a much lighter color with saturated PS (Li₂Sₓ, where 3≤x≤8) in the electrolyte solutions, indicating the lower PS solubility in the DFMN electrolytes, which is beneficial for suppressing the PS shuttle effect and improving the cell CE.

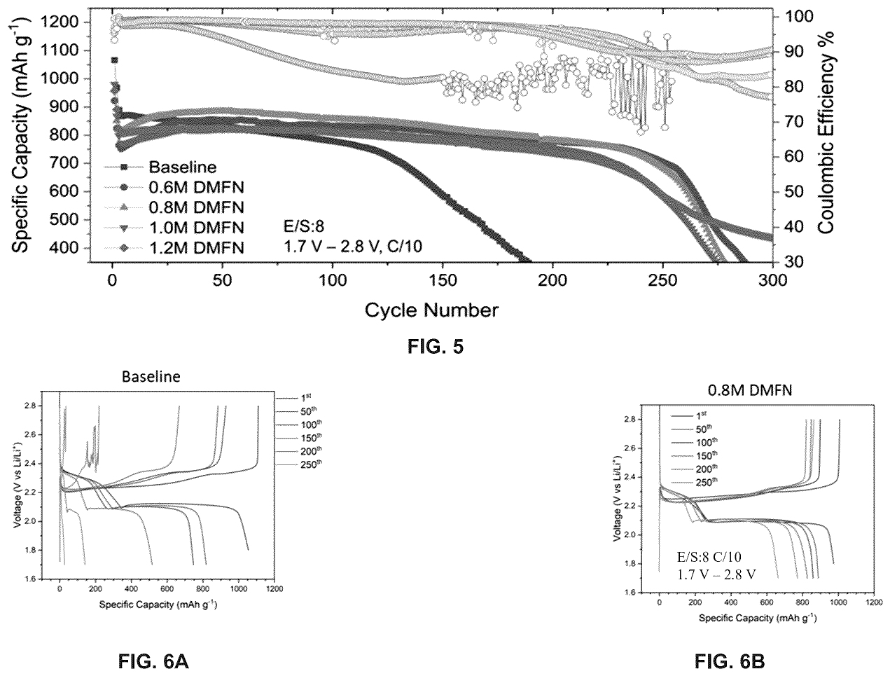

FIG. 5 shows the cycling performance of Li∥S cells using the different electrolytes of FIG. 2 at a charge/discharge rate of C/10 as can be seen in the brightly colored lines in the graph. The Li∥S cells use an S electrode with an areal mass loading of 4 mg-S cm⁻² and an electrolyte-to-sulfur (E/S) ratio of 8 μl/mg-S. The baseline electrolyte has higher initial capacity, compared to all DMFN electrolytes, but has slight capacity fading over 120 cycles. After 120 cycles, the cell cycled with the baseline electrolyte underwent rapid capacity fading, which indicates cell failure. This failure can be due to high reactivity with both the cathode and the anode and/or the high polysulfide dissolution that consumes the active S material from the S electrode. FIG. 5 also shows the CE over the cycling of the cells with the different electrolytes of FIG. 2 as can be seen in the faded lines in the graph. The baseline electrolyte shows a lower initial CE of 97%, compared to the 99+% CEs for the DMFN electrolytes. After 50 cycles, the CE of the cells with the baseline electrolyte also showed rapid decay, signifying the high reactivity of the electrolyte and electrodes. All DMFN electrolytes show slightly lower initial capacity, due to them being MSEs, but show a gradual increase over the first 50 cycles before stabilizing and maintaining high-capacity retention and CE for over 200 cycles, with 0.8M DMFN having the highest cycling capacity (˜900 mAh g⁻¹) and nearly the longest stable cycling before succumbing to fast decay after ˜250 cycles. The DMFN electrolytes significantly improve the Li∥S cell stability and longevity compared to the baseline electrolyte. The Li∥S cells were prepared with 4 mg cm⁻² S, 250 μm Li, an E/S ratio of 8 μl/mg-S, and were charged/discharged at C/10 rate where 1C=1000 mA g⁻¹.

FIGS. 6A and 6B show the charge/discharge curves of the Li∥S cells with FIG. 6A showing the results for the baseline electrolyte and FIG. 6B showing the results for the 0.8M DMFN electrolyte with both based on cycling at a C/10 charging and discharging rate. As shown in FIG. 6A, the baseline cell has a high capacity of 1050 mAh g⁻¹ in the first cycle, but its capacity decreases to 825 mAh g⁻¹ by the 50th cycle followed by a slight loss in capacity by the 100th cycle and undergoing an accelerated capacity-fading by the 150th cycle. As shown in FIG. 6B, the cell using 0.8M DMFN, although its initial capacity of 980 mAh g⁻¹ is lower than that of the baseline, it is much more stable over the entirety of its cycle life. Li∥S cells were prepared with 4 mAh cm⁻² S, 250 μm Li, an E/S ratio of 8 μl/mg-S. DMFN is an abbreviation of the electrolyte containing LiTFSI in the solvent mixture of DME, 2-MeTHF and TFEO with additive of LiNO3, wherein the #. #M in front of DMFN sets forth the molarity of the LiTFSI in the solution (e.g. 0.8M DMFN indicates a 0.8M concentration of LiTFSI in the electrolyte.

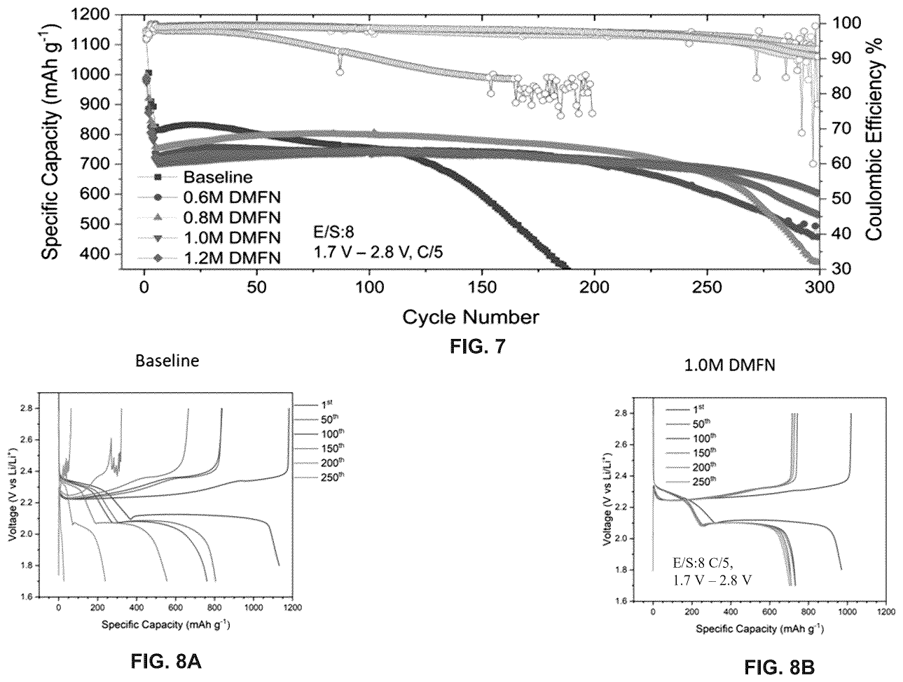

Like FIG. 5, FIG. 7 shows the cycling performance of Li∥S cells with different electrolytes, but instead of using a charge/discharge rate of C/10, a rate of C/5 is used. As with the results shown in FIG. 5, the baseline electrolyte showed a higher initial capacity, but significantly worse long-term cycling stability with rapid capacity fading after ˜120 cycles. For the DMFN electrolytes, the 0.8M electrolyte still maintained the highest capacity of the DMFN series; however the slight increase of salt concentration to 1.0M LiTFSI improved the long-term stability and achieved 300 cycles before undergoing rapid capacity fading. While a further increase in salt concentration to 1.2M LiTFSI still showed an improvement in capacity relative to the 0.8M electrolyte, its stability is less than that of the 1.0M electrolyte. The Li∥S cells were prepared with 4 mg cm 2 S, 250 μm Li, an E/S ratio of 8 μl/mg-S.

FIGS. 8A and 8B, like FIGS. 6A and 6B, show the charge/discharge curves of the Li∥S cells but instead of being based on a charge/discharge rate of C/10, they are based on a charge/discharge rate of C/5. FIG. 8A shows the curves for a cell using the baseline electrolyte while FIG. 8B shows curves for a cell using the 1.0M DMFN electrolyte. Following the same trend as shown in FIGS. 6A and 6B, the cell cycled with the baseline electrolyte shows fairly good stability within the first 100 cycles, followed by accelerated capacity fading by the 150th cycle. Meanwhile, the 1.0M DMFN shows a negligible loss in capacity and polarization in the voltage profile at over 250 cycles which signifies the low reactivity of the electrolyte with the S and/or Li electrodes. The Li∥S cells were prepared with 4 mAh cm⁻² S, 250 μm Li, an E/S ratio of 8 μl/mg-S.

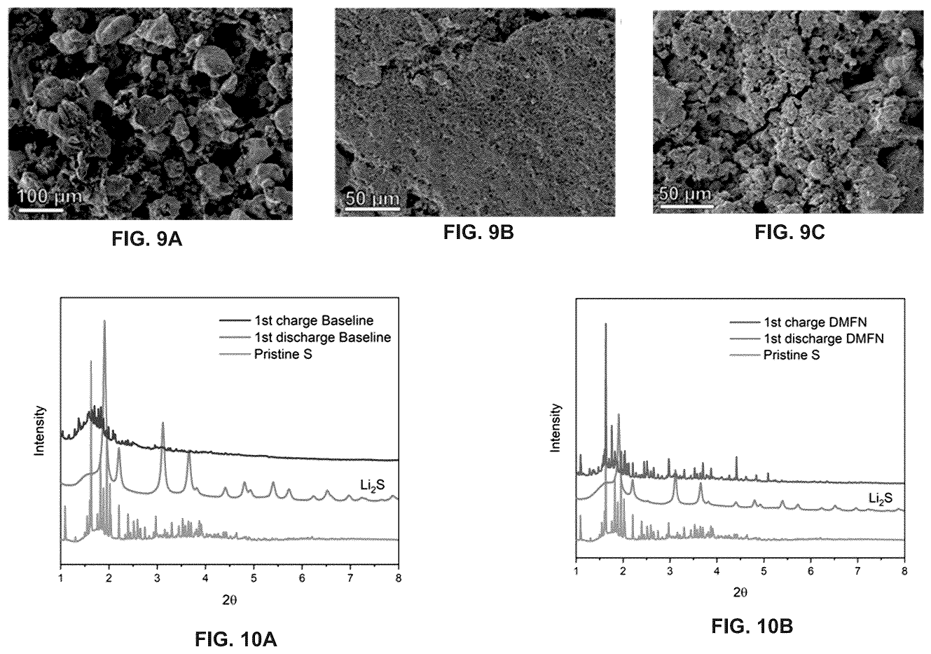

FIG. 9A provides an SEM surface view of a pristine S electrode. FIG. 9B provides an SEM view of an S electrode after 300 cycles at a charge/discharge rate of C/5 using the baseline electrolyte while FIG. 9C provides a view of an S electrode after 300 cycles at a charge/discharge rate of C/5 using a 1.0M DMFN electrolyte. Comparing the views of FIGS. 9A and 9B, the electrode shown in FIG. 9B shows that the cycling completely degraded the S electrode. There is agglomeration and removal of S particles on the majority of the electrode, leaving behind primarily the carbon nanotube (CNT) substrate of the electrode. Meanwhile, the 1.0M DMFN cycled S electrode of FIG. 9C maintains a high level of structural integrity of the S particles and of the overall electrode.

FIGS. 10A and 10B show the X-ray diffraction (XRD) pattern of S electrodes in the pristine state after the first discharge and charge formation cycle at a C/20 charge/discharge rate with FIG. 10A showing results when using the baseline electrolyte and FIG. 10B showing the result when using the 1.0M DMFN electrolyte. The pristine electrode patterns are the same in both FIGS. 10A and 10B. After the first cell discharge, the XRD patterns reveal the formation of Li₂S on the S electrodes in both electrolytes, showing no significant difference between the two S electrodes after the first discharge step in the two electrolytes. However, after the first charge step, there is a significant difference in the XRD patterns of S between the two electrodes from the two electrolytes. The XRD of the S electrode from the baseline electrolyte reveals that the structural integrity of S in the electrode degraded, with a decrease in the peak signal integrity and intensity. The S electrode cycled in the 1.0M DMFN electrolyte maintained peak integrity signifying the enhanced reversibility of the S electrode with the developed electrolyte compared to the baseline electrolyte.

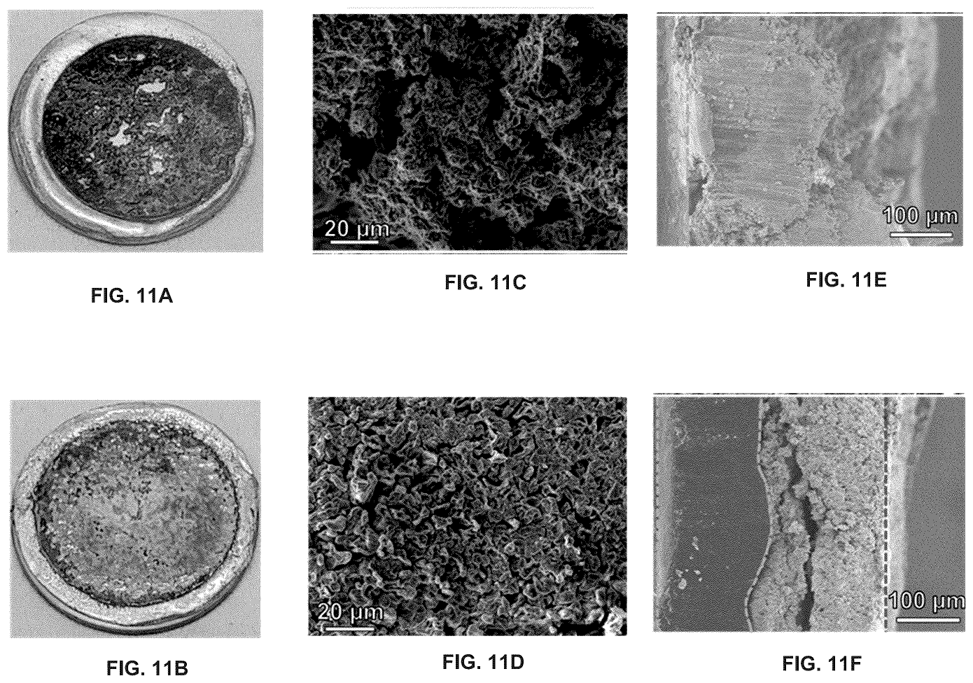

FIGS. 11A-11F show the morphologies of cycled Li after 300 cycles at a C/5 rate for both charging and discharging. FIGS. 11A and 11B provide photographs of the Li metal after cycling which show significant discoloration and deep pitting in the Li cycled in the baseline electrolyte (FIG. 11A) compared with the Li cycled in the 1.0M DMFN electrolyte (FIG. 11B). FIGS. 11C and 11D provide top-down SEM images showing inhomogeneous and rough plating of Li cycled in the baseline electrolyte (FIG. 11C) while a more homogenous and dense Li morphology exists when cycling occurred in the 1.0M DMFN electrolyte (FIG. 11D). FIGS. 11E and 11F also provide SEM images like those of FIGS. 11C and 11D but with the images being cross-sectional instead of top-down where the images reveal the Li cycled in the baseline electrolyte is inhomogeneous and mostly reacted Li metal (FIG. 11E) while the Li cycled in the 1.0M DMFN electrolyte maintains about 150 μm of unreacted Li metal and a surface layer that is densely packed (FIG. 11F). In FIGS. 11E and 11F, the yellow dashed lines show the bulk Li boundaries that are not corroded during cycling while in FIG. 11F, the red dashed line indicates the surface of the SEI. These images signify improved stability and decreased reactivity with the DMFN electrolyte compared to the baseline electrolyte. The Li∥S cells were prepared with 4.0 mg cm 2 S, 250 μm Li, and an E/S ratio of 8 μl/mg-S.

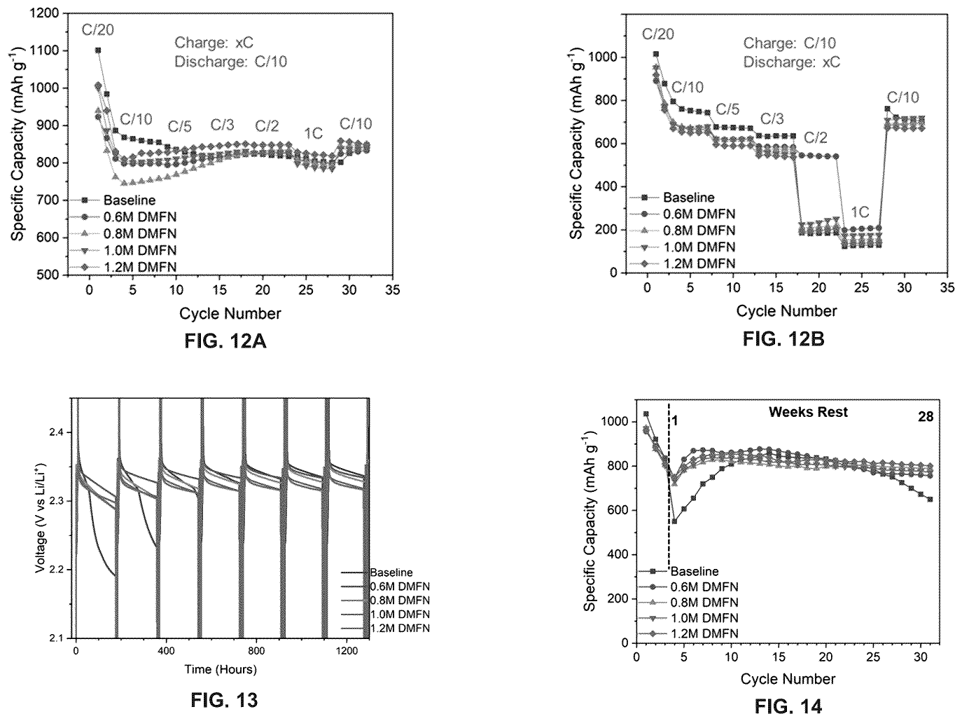

Rate capability testing of the baseline and DMFN electrolytes in Li∥S cells was conducted for both charge and discharge rates after 2 formation cycles at a C/20 rate where 1C=1000 mA g⁻¹. The cells for charge rate capability tests were charged at C/10, C/5, C/3, C/2, 1C and again at C/10 for 5 cycles each but with all being discharged at a C/10 rate. For discharge rate capability tests, the cells were charged at C/10 but discharged at C/10, C/5, C/3, C/2, 1C and again at C/10 for 5 cycles each. In the charge rate test (FIG. 12A), the DMFN electrolytes showed lower specific capacity than the baseline electrolyte at the initial cycles at C/10 and C/5 rates, but after that differences were reduced with some DMFN electrolytes showing somewhat higher specific capacity at charge rates from C/3 to 1C. The DMFN electrolytes maintained similar capacity to the baseline electrolyte, even while having higher bulk viscosity and lower ionic conductivity. Similarly, in the discharge rate capability tests (FIG. 12B), the baseline electrolyte shows a slightly higher specific capacity than the DMFN electrolytes at the discharge rate from C/10 to C/3 which is reversed at higher discharge rates of C/2 and 1C. However, as the discharge rate increased to C/2, only the 0.6M DMFN electrolyte was able to maintain full cycling at this higher discharge current density. The Li∥S cells were prepared with 4 mg cm 2 S, 250 μm Li, and an E/S ratio of 8 μl/mg-S.

FIG. 13 shows the voltage decay of Li—S batteries from a fully charged state. The Li—S cells with different electrolytes were first charged to 2.8 V and then rested for 1 week (168 h) before discharging them. As shown in FIG. 13, the cell with the baseline electrolyte had a significant voltage drop over the course of the week due to the higher solubility of LiPS causing higher reactivity between the electrolyte and electrodes. All the DMFN containing cells showed much better voltage stability during the week-long resting period. It takes multiple weeks for the voltage profile of the baseline electrolyte to stabilize while the DMFN electrolytes maintain a low drop in voltage from the start which signifies a lower reactivity with the S and Li electrodes in the charged state. The Li∥S cells were prepared with 4.0 mg cm 2 S, 250 μm Li, an E/S ratio of 8 μl/mg-S and were charged to 2.8 V at a current of C/10 after 2 formation cycles at C/20 where 1C=1000 mA g⁻¹. The cells were rested for 1 week (168 h) before performing a full cycle and resting again.

The cells, after a self-discharge test (i.e. after a resting period of 1 week (168 h) in a charged state and a voltage check to determine the voltage drop) were discharged, and then one regular charge/discharge cycle was conducted to see how storage affected the capacity. As shown in FIG. 14, there was a significant drop in capacity for the cell with the baseline electrolyte after one full cycle at a C/10 rate and after resting for a week and discharging the cell. Compared to the baseline electrolyte test, all DMFN electrolyte containing cells had a much less significant drop in capacity after resting for a week. After continuing the charge, resting, and discharge steps, the DMFN containing cells began to stabilize after 3 or 4 weeks, maintaining a high discharge capacity, while the baseline electrolyte took ˜12 weeks to retain its initial capacity. Furthermore, the cell with the baseline electrolyte was the first to experience capacity fading, while all the DMFN containing cells maintained their high-level of stability after repeating the resting and cycling steps for 28 weeks. The results show the DMFN electrolytes had much better stability with the S and Li electrodes and underwent less self-discharge reactivity in a Li∥S cell when held in a charged state. The Li∥S cells were prepared with 4 mg cm⁻² S, 250 μm Li, an E/S ratio of 8 μl/mg-S and were charged to 2.8 V at a current of C/10 after 2 formation cycles at C/20. The cells were rested for 1-week (168 h) intervals after being fully charged before performing a full cycle and resting again.

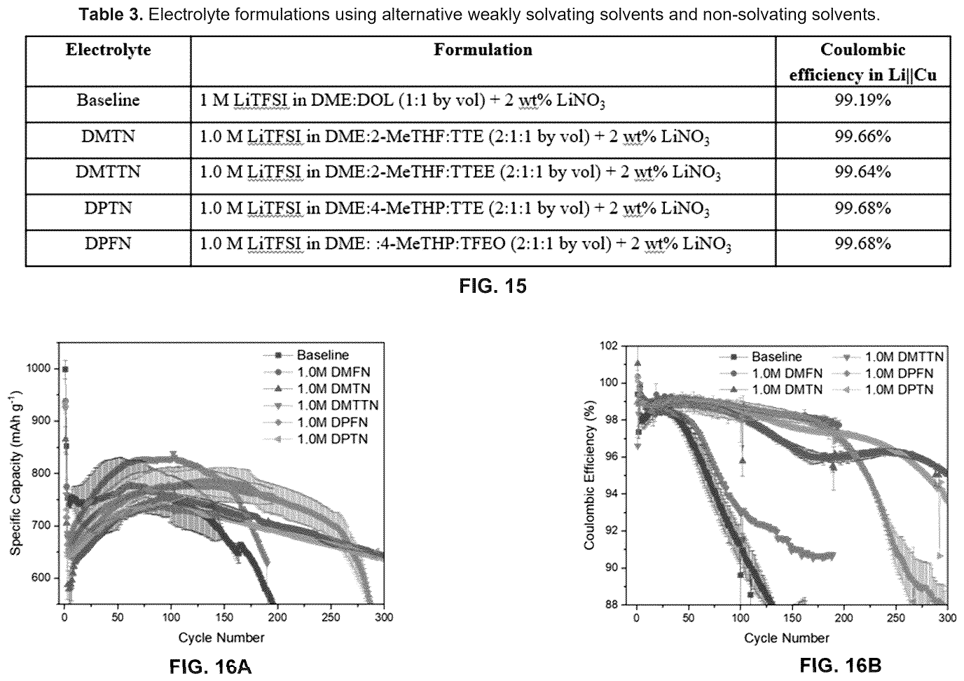

Besides the use of 2-MeTHF and TFEO as weakly and non-solvating solvents in the ternary solvent mixture for MSEs for Li∥S batteries, other weakly and non-solvating solvents were also employed as electrolyte components for the MSEs for Li∥S batteries. By replacing the weakly solvating solvent 2-MeTHF with 4-MeTHP and/or replacing the non-solvating solvent (or diluent) TFEO with either TTE or TTEE as more cost-effective alternative diluents, four more MSEs with abbreviations DMTN, DMTTN, DPTN and DPFN were prepared. Their specific formulations are listed in Table 3 of FIG. 15. The Li CEs were tested for each electrolyte and are included in the table of FIG. 15. The Li CEs of the new formulations have similar values to that of the 1.0M DMFN electrolyte of FIG. 2 indicating that the new co-solvents still retain a high level of compatibility with Li metal. Li∥S cells were also assembled with these new electrolytes using a S electrode with an areal mass loading of 4 mg-S cm 2 and an E/S ratio of 8 μl/mg-S. The cells were processed through 2 formation cycles at C/20 and then cycled at a charge/discharge rate of C/10, where 1C=1000 mA cm⁻². FIGS. 16A and 16B show the same type of data found in FIG. 5 with the difference being that the specific capacity data and the CE data are divided into separate charts and the data for FIGS. 16A and 16B come from the electrolytes of FIG. 15 as opposed to the electrolytes of FIG. 2. The cycling profiles in FIGS. 16A and 16B show that the new formulations of electrolytes also outperform the baseline electrolyte in long-term cycling stability though their initial capacities were lower than the baseline electrolyte as were initial capacities shown in shown in FIG. 5 for the electrolytes of FIG. 2. The Li∥S cell cycling in the DPFN electrolyte began to show capacity fading after 180 cycles. The cells cycled in the DMTTN electrolyte initially showed largest ramp up in specific capacity and increased discharge capacity over the first 100 cycles, however the electrolyte was found to have low cycling CE and rapid capacity decay after 120 cycles indicating that the electrolyte with the TTEE diluent, though better than the baseline electrolyte, did not provide as much improvement in stability with an S electrode as desired. When comparing the cycling performance of the electrolytes using the diluents, TFEO and TTE, it is found that the stability of the cells using TTE-based MSEs, i.e. DMTN and DPTN (containing 2-MeTHF and 4-MeTHP, respectively), showed slightly lower capacities than the cells with DPFN (the TFEO-based electrolyte), but the capacities underwent gradual capacity decay over 300 cycles instead of an eventual rapid capacity decay that is observed in the TTEE-based electrolyte. Considering the significantly lower cost of TTE than TFEO, the MSEs with TTE as the non-solvating solvent (or diluent) for Li∥S batteries appear to be feasible alternatives if not the best possibility for at least some applications. Li∥S cells were prepared with 4 mg cm⁻² S, 250 μm Li, an E/S ratio of 8 μl/mg-S and were charged/discharged at C/10 rate where 1C=1000 mA g⁻¹.

The utilization of redox mediating electrolyte additives was also investigated to facilitate the accelerated conversion of longer-chain LiPS (Li₂S₃-8) to short-chain LiPS (Li₂S₁-2) through the mechanism of lowering the thermodynamic energy barrier required for conversion of the LiPSs.

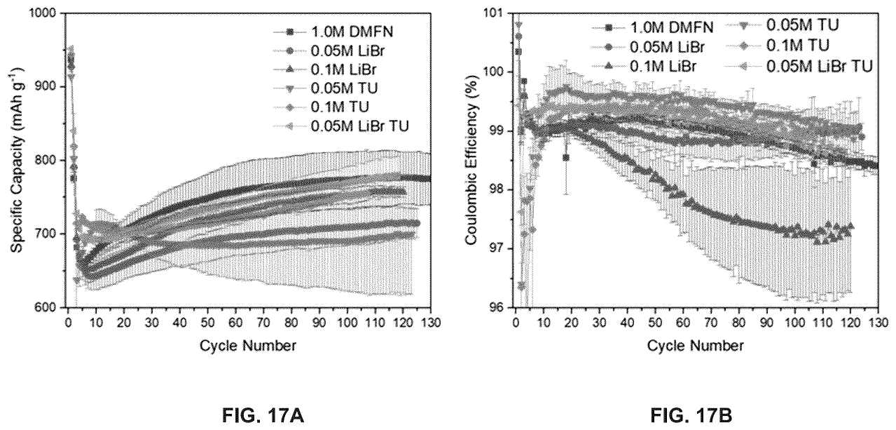

Lithium bromide (LiBr) and thiourea (TU) were investigated at selected concentrations in the 1.0M DMFN electrolyte and cycled in Li∥S cells under the same mass loading, E/S ratio, and cycling conditions. FIGS. 17A and 17B provide performance graphs, similar to those of FIGS. 16A and 16B but for cells that include the 1.0 M DMFN electrolyte of FIGS. 16A and 16B as well as other electrolytes that provide additional additives to the DMFN including (1) 0.05M LiBr, (2) 0.1LiBR, (3) 0.05 TU, (4) 0.1 TU, and (5) a combination of 0.05M LiBr and 0.05M TU. The cycling performance, shown in FIG. 17 shows that the inclusion of the additives to the 1.0M DMFN electrolyte generally lowered the initial capacity compared to the 1.0M DMFN cells without these additional additives. However, the cells with the additional additives maintain good stability and similar capacity ramp up behavior to the DMFN electrolytes. The TU additives were found to improve the CE in the full cell that can indicate a reduction of cell overcharging and improved conversion efficiency by reducing undesired side reactions with LiPSs. The combination of LiBr and TU at a 0.05M concentration each appears to have a synergistic effect for maintaining a high capacity and CE in the full cell, compared to the individual additives.

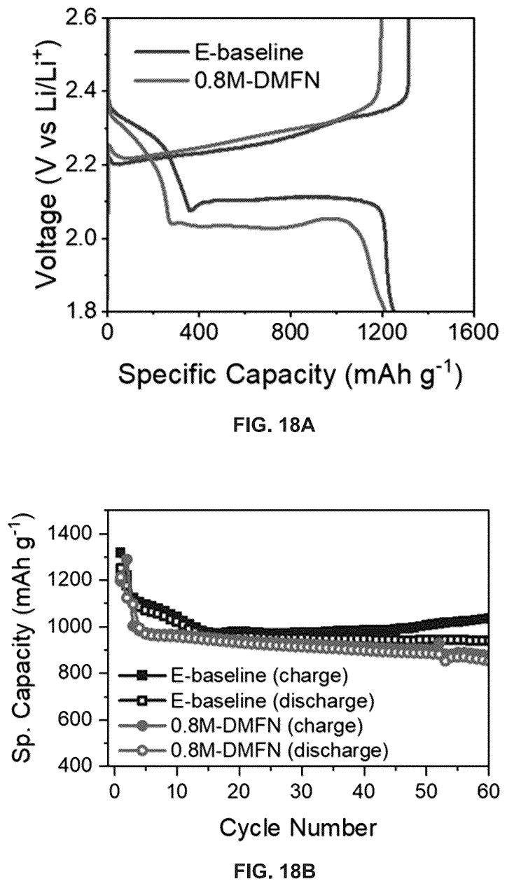

FIG. 18A provides comparison plots of Voltage (V vs. Li/Li+) versus specific capacity of 1 Ah Li∥S pouch cells for both the baseline electrolyte and the 0.8M-DMFN electrolyte while FIG. 18B provides specific capacity versus cycle number showing the change of both charge and discharge capacities with cycling for the same pouch cells with the same two electrolytes where it can be seen that the 0.8M-DMFN electrolyte cell shows better cycling stability than the E-baseline electrolyte cell where the latter exhibits large overpotential after 40 cycles because the extra charging capacity from unwanted side reactions leads to low Coulombic efficiency and ultimately to cell death. More specifically these figures show performance of Li∥S 1-Ah pouch cells wherein FIG. 18A shows first cycle voltage profiles at a C/20 rate and FIG. 18B shows cycling performance at a C/10 rate. The E/S ratio is 5.2 μL/mg-S for the experiments of both FIGS. 18A and 18B. The cells were cycled at C/20 for two formation cycles at 1.8-2.6 V followed by C/10 rate at 1.7-2.6 V at 25° C.

The invention disclosed here is not limited to the above embodiments. In some alternatives, the percentages of the components may be varied. For example: (1) the highly solvating solvent may provide 20-80% of the electrolyte or solvents in the electrolyte, the weakly solvating solvent may provide 1-80% of the electrolyte or solvents in the electrolyte, the non-solvating solvent or diluent may provide 1-80% of the electrolyte or solvent/diluents in the electrolyte, other additives may make up 0-10% of the electrolyte, while the metal salt (e.g. a Li salt) may provide 5-50% of the electrolyte. In some variations, the each of the highly solvating solvent, the weakly solvating solvent, and that non-solvating solvent may be a single material while in other variations, one or more of these may be formed from two or more materials within their class. In some variations a battery comprising the electrolyte has a number of useful charging/discharging cycles greater than 100 before a specific capacity drops to less than 80% of peak capacity, more preferably greater than 200, even more preferably greater than 250, even more preferably greater than 300. In still other variations the electrolytes, mutatis mutandis, can be applied to a variety of other electrochemical systems, including Na—S batteries, K—S batteries, Mg—S batteries, Al—S batteries, and the like.

### ADDITIONAL REMARKS

Any materials referenced herein (including any Appendices) are incorporated herein by reference as if set forth in full. To the extent that any definitions or other teachings set forth in material incorporated herein by reference contradict teachings set forth directly herein (i.e., not incorporated by reference), the order of precedence given to the definitions or other teachings are: (1) teachings set forth directly in the body of this application and then, (2) teachings in the Appendices, and then any other material incorporated herein by reference with incorporated materials having more recent dates taking precedence over incorporated materials have earlier dates.

It is intended that the aspects of the invention set forth specifically herein or otherwise ascertained from the teachings here of represent independent invention descriptions which Applicant contemplates as full and complete, and that Applicant believes may be set forth as independent claims without needing additional limitations or elements from other embodiments or aspects set forth herein for interpretation or clarification. It should also be understood that any variations of the aspects (as well as variations in any embodiments) set forth herein represent individual and separate features that may form separate independent claims, be individually added to independent claims, or be added as dependent claims to further define an invention being claimed by such dependent claims.

While various preferred embodiments of the invention are shown and described, it is to be distinctly understood that this invention is not limited thereto but may be variously embodied within the scope of the following claims. From the foregoing description, it will be apparent that various changes may be made without departing from the spirit and scope of the invention.

We claim:

1. A moderately solvating electrolyte for a rechargeable lithium-sulfur battery comprising:
a) a lithium salt;
b) a first highly solvating solvent for lithium polysulfides (LiPSs);
c) a second weakly solvating solvent for LiPSs; and
d) a third non-solvating solvent or diluent for LiPSs.

2. The electrolyte of claim 1 wherein the first highly solvating solvent comprises a solvent selected from the group consisting of:
(b1) 1,2-dimethoxyethane (DME);
(b2) 1,3-dimethyl-2-imidazolidinone (DMI);
(b3) dimethylformamide (DMF);
(b4) dimethyl sulfoxide (DMSO); and
(b5) a combination of two or more of (b1)-(b4).

3. The electrolyte of claim 2 wherein the second weakly solvating solvent comprises a solvent selected from the group consisting of:
(c1) 2-methyltetrahydrofuran (2-MeTHF);
(c2) 1,2-diethoxyethane (DEE);
(c3) tetrahydropyran (THP);
(c4) 4-methyl-tetrahydropyran (4-MeTHP); and
(c5) a combination of two or more of (c1)-(c3).

4. The electrolyte of claim 3 wherein the third non-solvating solvent or diluent comprises a solvent or diluent selected from the group consisting of:
(d1) tris(2,2,2-trifluoroethyl) orthoformate (TFEO);
(d2) triethyl orthoformate (TEO),
(d3) trimethyl orthoformate (TMO);
(d4) 1,1,2,2-tetrafluorethyl-2,2,3,3-tetrafluoropropyl ethane (TTE);
(d5) bis(2,2,2-trifluoroethyl) ether (BTFE);
(d6) 1H,1H,5H-octafluoropentyl 1,1,2,2-tetrafluoroethyl ether (OTE);
(d7) 1,2-bis(1,1,2,2-tetrafluoroethoxy) ethane (BTFEE);
(d8) 2,2,2-trifluoroethyl 1,1,2,2-tetrafluoroethyl ether (TTEE);
(d9) 1,1,1,3,3,3-hexafluoro-2-(fluoromethoxy) propane (HFP);
(d10) ethyl 1,1,2,2-tetrafluoroethyl ether (ETE);
(d11) ethyl nonafluorobutyl ether (ENFBE);
(d12) methyl nonafluorobutyl ether (MNFBE);
(d13) methyl butyl ether (MBE);
(d14) ethyl butyl ether (EBE);
(d15) dibutyl ether (DBE); and
(d16) a combination of two or more of (d1)-(d15).

5. The electrolyte of claim 4 additionally comprising:
(e) a redox mediating additive different from the salt, solvent of diluent of (a), (b), (c), and (d).

6. The electrolyte of claim 5 wherein the redox mediating additive comprises an additive selected from the group consisting of:
(e1) lithium bromide (LiBr),
(e2) thiourea (TU), and
(e3) a combination of LiBr and TU.

7. The electrolyte of claim 6 wherein the highly solvating solvent provides a solubility for LiPS over 0.5 M, the weakly solvating solvent provides a solubility for LiPS in the range of 0.05 M to 0.5 M, and the non-solvating solvent or diluent provides a solubility for LiPS below 0.05 M while the electrolyte as a whole provides a solubility for the LiPS in the range of 0.05M to 0.5 M.

8. The electrolyte of claim 7 wherein the lithium salt is provided in a range selected from the group consisting of: (A) 0.1 M to 2.0 M, (B) 0.3 M to 1.5 M, and (C) 0.6 M to 1.0 M.

9. A moderately solvating electrolyte for a rechargeable metal-sulfur battery comprising:
a salt of the metal;
a first highly solvating solvent for PSs;
a second weakly solvating solvent for PSs; and
a third non-solvating solvent or diluent for PSs.

10. The electrolyte of claim 9 wherein the metal comprises a metal selected from the group consisting of: (A) lithium, (B) sodium, (C) potassium, (D) magnesium, and (E) aluminum.

11. A metal-sulfur battery, comprising:
a) a cathode, comprising sulfur;
b) an anode, comprising the metal;
c) an electrolyte, comprising:
i. a salt of the metal;
ii. a first highly solvating solvent for PSs;
iii. a second weakly solvating solvent for PSs; and
iv. a third non-solvating solvent or diluent for PSs.

12. The metal-sulfur battery of claim 11 wherein the metal comprises a metal selected from the group consisting of (A) lithium, (B) sodium, (C) potassium, (D) magnesium, and (E) aluminum.

13. The metal-sulfur battery of claim 12 wherein the metal comprises lithium, the PSs comprise LiPS, and the metal-sulfur battery comprises a lithium-sulfur battery.

14. The lithium-sulfur battery of claim 13 wherein the first highly solvating solvent comprises a solvent selected from the group consisting of:
(ii1) 1,2-dimethoxyethane (DME);
(ii2) 1,3-dimethyl-2-imidazolidinone (DMI);
(ii3) dimethylformamide (DMF);
(ii4) dimethyl sulfoxide (DMSO); and
(ii5) a combination of two or more of (ii1)-(ii4).

15. The lithium-sulfur battery of claim 14 wherein the second weakly solvating solvent comprises a solvent selected from the group consisting of:
(iii1) 2-methyltetrahydrofuran (2-MeTHF);
(iii2) 1,2-diethoxyethane (DEE);
(iii3) tetrahydropyran (THP);
(iii4) 4-methyl-tetrahydropyran (4-MeTHP); and
(iii5) a combination of two or more of (iii1)-(iii4).

16. The lithium-sulfur battery of claim 15 wherein the third non-solvating solvent or diluent, comprises a solvent or diluent selected from the group consisting of:
(iv1) tris(2,2,2-trifluoroethyl) orthoformate (TFEO);
(iv2) triethyl orthoformate (TEO);
(iv3) trimethyl orthoformate (TMO);
(iv4) 1,1,2,2-tetrafluorethyl-2,2,3,3-tetrafluoropropyl ethane (TTE);
(iv5) bis(2,2,2-trifluoroethyl) ether (BTFE);
(d6) 1H, 1H,5H-octafluoropentyl 1, 1,2,2-tetrafluoroethyl ether (OTE);
(iv7) 1,2-bis(1,1,2,2-tetrafluoroethoxy) ethane (BTFEE);
(iv8) 2,2,2-trifluoroethyl 1,1,2,2-tetrafluoroethyl ether (TTEE);
(iv9) 1,1,1,3,3,3-hexafluoro-2-(fluoromethoxy) propane (HFP);
(iv10) ethyl 1,1,2,2-tetrafluoroethyl ether (ETE);
(iv11) ethyl nonafluorobutyl ether (ENFBE);
(iv12) methyl nonafluorobutyl ether (MNFBE);
(iv13) methyl butyl ether (MBE);
(iv14) ethyl butyl ether (EBE);
(iv15) dibutyl ether (DBE); and
(iv16) a combination of two or more of (iv1)-(iv15).

17. The lithium-sulfur battery of claim 16 wherein the electrolyte additionally comprises:
(v) a redox mediating additive different from the salt of (i), solvents or (ii) and (iii), and the diluent of (iv).

18. The lithium-sulfur battery of claim 17 wherein the redox mediating additive comprises an additive selected from the group consisting of:
(v1) lithium bromide (LiBr),
(v2) thiourea (TU), and
(v3) a combination of LiBr and TU.

19. The lithium-sulfur battery of claim 17 wherein the highly solvating solvent provides a solubility for LiPS over 0.5 M, the weakly solvating solvent provides a solubility for LiPS in the range of 0.05 M to 0.5 M, the non-solvating solvent or diluent provides a solubility for LiPS below 0.05 M, and the electrolyte as a whole provides a solubility for the LiPS in the range of 0.05M to 0.5 M.

20. The lithium-sulfur battery of claim 18 wherein the lithium salt is provided in a range selected from the group consisting of: (A) 0.1 M to 2.0 M, (B) 0.3 M to 1.5 M, and (C) 0.6 M to 1.0 M.

21. The lithium-sulfur battery of 20 additionally comprising a separator.

22. The lithium-sulfur battery of claim 20 wherein the battery provides a number of useful charging-discharging cycles prior to a specific capacity of the battery falling below 80% of a peak specific capacity of the battery, wherein the number of cycles is selected from the group consisting of: (A) greater than 100 cycles, (B) greater than 200 cycles, (C) greater than 250 cycles, and (D) greater than 300 cycles.
